(19) United States
(12) Patent Application Publication
(10) Pub. No.: US 2005/0137076 A1
(43) Pub. Date: Jun. 23, 2005

(54) Transparent fused crystalline ceramic, and method of making the same

(75) Inventors: Anatoly Z. Rosenflanz, Maplewood, MN (US); Thomas J. Anderson, Woodbury, MN (US); Ahmet Celikkaya, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/739,439

(22) Filed: Dec. 18, 2003

(51) Int. Cl. C04B 35/48; C09K 3/14; C04B 35/10

(52) U.S. Cl. 501/103; 51/307; 51/308; 51/309; 501/127; 501/105; 264/80

(57) ABSTRACT

Transparent fused crystalline ceramic, and methods of making and using the same. Embodiments of transparent fused crystalline ceramics according to the present invention are useful, for as abrasive particles, reflective and optical components, and as grinding and sand blasting media.

### BACKGROUND

Fused alumina-zirconia abrasive particles are typically made by charging a furnace with an alumina source such as aluminum ore or bauxite, a zirconia source, and optionally stabilizing oxides such as yttria, ceria, magnesia, rare earth oxides, and titania, as well as other incidental impurities and desired additives, heating the material above its melting point, cooling the melt to provide a solidified mass, crushing the solidified mass into particles, and then screening and grading the particles to provide the desired abrasive particle size distribution. For fused alumina-zirconia abrasive particles, the amount of alumina source is typically about 15-85 percent by weight, and the amount of zirconia, about 85-15 percent by weight. Processes for making the fused alumina-zirconia. (e.g., abrasive particles) typically include removal of impurities from the melt prior to the cooling step. The residual impurities (e.g., silica, titania, and iron oxides) are generally concentrated at the boundaries of crystals and eutectic cells. The impurities at the crystal and/or cell boundaries may be present in crystalline and/or glassy states, and/or in a dissolved state in the crystal structure of, for example, the alumina and/or zirconia. A common impurity in fused alumina-zirconia ceramics made via arc melting processes is carbon. Although not wanting to be bound by theory, it is believed that carbon detrimentally effect the alumina-zirconia ceramics if such ceramics are sufficiently heated (e.g., generally above about 350° C.) in an oxidizing atmosphere.

In general, it is known that the cooling rate affects the morphology (e.g., size) of the eutectic cells containing eutectic laminar structures, and the spacing between the eutectic laminae (i.e., the thickness of the laminae). Further, in general, it is known that higher cooling rates typically lead to smaller eutectic cells and thinner eutectic laminae. Also, in general, it is known that the cooling rate may affect the phase constituency of the resulting ceramic. For example, the higher cooling rates typically preferentially produce more tetragonal (cubic) zirconia. Generally, in the absence of any stabilizers (such as yttria, magnesia, etc.), the smaller tetragonal zirconia crystals are more stable against transformation to a monoclinic phase. Additionally, if the heat removal from the melt is done in a directional manner (e.g., in the case of book molds), the cells containing the eutectic structures may grow asymmetrically in the direction of heat removal (i.e., the cell growth may become oriented or elongated). Typically, smaller cell sizes are more desirable.

Although not wanting to be bound by theory, it is believed, the presence of impurities, cell boundaries, and/or coarse crystals alone or in combination interact with the visible light causing scattering of light within the ceramic and causes opacity of the ceramic.

There continues to be a desire for new abrasion resistant, transparent ceramic materials, as well as methods for making the same.

### SUMMARY

In one aspect, the present invention provides transparent fused crystalline (including polycrystalline) ceramic comprising in a range from 45 to 80 (in some embodiments, in a range from 50 to 70) percent by weight Al₂O₃ and in a range from 55 to 20 percent by weight ZrO₂ (in some embodiments, in a range from 50 to 30), based on the total weight of the transparent fused crystalline ceramic. Transparent fused crystalline ceramics according to the present invention collectively comprise at least 65 (in some embodiments, at least 70, 75, 80, 85, 90, 95, or even at least 100) percent by weight Al₂O₃ and ZrO₂, based on the total weight of the transparent fused crystalline material.

In another aspect, the present invention provides a method of making transparent fused crystalline ceramic according to the present invention, the method comprising:
flame forming a melt, the melt comprising collectively at least 65 (in some embodiments, 70, 75, 80, 85, 90, 95, 99, or even at least 100) percent by weight Al₂O₃ and ZrO₂, (based on the total weight of the melt); and
cooling the melt to directly provide the transparent fused crystalline ceramic (e.g., particles (e.g., abrasive particles)). In some embodiments, the flame forming is conducted at no more than 2500° C. (in some embodiments, in a range from 1900° C. to 2500° C., or even in a range from 2000° C. to 2500° C.). In some embodiments, at least a portion of cooling the precursor particles comprises immersing the melt into a cooling medium, such as a fluid (e.g., water) and/or between rollers.

In another aspect, the present invention provides a method of making transparent fused crystalline ceramic particles according to the present invention, the method comprising:
flame forming a melt, the melt comprising collectively at least 65 (in some embodiments, 70, 75, 80, 85, 90, 95, 99, or even at least 100) percent by weight Al₂O₃ and ZrO_{2,} based on the total weight of the melt);
shaping the melt into precursor particles (e.g., spheres); and
cooling the precursor particles to directly provide the transparent fused crystalline ceramic particles (e.g., abrasive particles). In some embodiments, the flame forming is conducted at no more than 2500° C. (in some embodiments, in a range from 1900° C to 2500° C., or even in a range from 2000° C. to 2500° C.). In some embodiments, at least a portion of cooling the precursor particles comprises immersing the melt into a cooling medium, such as a fluid (e.g., water) and/or between rollers.

In another aspect, the present invention provides a method of making transparent fused crystalline ceramic particles according to the present invention, the method comprising:
flame forming a melt, the melt comprising collectively at least 65 (in some embodiments, 70, 75, 80, 85, 90, 95, 99, or even at least 100) percent by weight Al₂O₃ and ZrO₂, based on the total weight of the melt);
cooling the melt to provide fused crystalline, eutectic alumina-zirconia material; and
crushing the transparent fused crystalline ceramic to provide the transparent fused crystalline ceramic particles (e.g., abrasive particles). In some embodiments, the flame forming is conducted at no more than 2500° C. (in some embodiments, in a range from 1900° C. to 2500° C., or even in a range from 2000° C. to 2500° C.). In some embodiments, cooling the melt may be facilitated, for example, by immersing the melt into a cooling medium, such as a fluid (e.g., water), and/or between rollers (e.g., steel rollers). Further, the rollers may also be immersed in the cooling medium.

In this application:
“alumina-zirconia” means comprising collectively at least 65% (in some embodiments, at least 70%, 75%, 80%, 85%, 90%, 95%, or even 100%) by weight, on a theoretical oxide basis, Al₂O₃ and ZrO_{2,} and may further comprise, for example, zirconia stabilizers such as yttria, calcia, magnesia, ceria, or rare earth oxides;
“cell size” refers to the largest dimension of the eutectic cell;
“complex metal oxide” refers to a metal oxide comprising two or more different metal elements and oxygen (e.g., CeAl₁₁O₁₈, Dy₃Al₅O₁₂, MgAl₂O₄, and Y₃Al₅O₁₂)
“complex Al₂O ₃.metal oxide” refers to a complex metal oxide comprising, on a theoretical oxide basis, Al₂O₃ and one or more metal elements other than Al (e.g., CeAl₁₁O₁₈, Dy₃Al₅O₁₂, MgAl₂O₄, and Y₃Al₅O₁₂);
“complex Al₂O₃.Y₂O₃” refers to a complex metal oxide comprising, on a theoretical oxide basis, Al₂O₃ and Y₂O₃ (e.g., Y₃Al₅O₁₂);
“complex Al₂O₃.REO” refers to a complex metal oxide comprising, on a theoretical oxide basis, Al₂O₃ and rare earth oxide (e.g., CeAl₁₁O₁₈ and Dy₃Al₅O₁₂);
“eutectic cell” refers to distinct regions of a eutectic within which laminar microstructure is exhibited; typically, the orientation of the laminae are distinctly different among the eutectic cells, and the thickness of the laminae and the crystals are larger at the eutectic cell boundaries;
“eutectic” refers to laminar structure formed from melts comprising a eutectic composition;
“feed particles” refers to the particles fed into a flame to form a melt;
“fused” refers to crystalline material cooled directly from a melt or crystalline material made by heat-treating crystalline material cooled directly from a melt (e.g., alpha alumina made by heat-treating transitional alumina cooled directly from a melt);
“polycrystalline” refers to materials comprising a multitude of crystals;
“rare earth oxides” refers to cerium oxide (e.g., CeO₂), dysprosium oxide (e.g., Dy₂O₃), erbium oxide (e.g., Er₂O₃), europium oxide (e.g., Eu₂O₃), gadolinium oxide (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium oxide (e.g., Tb₂O₃), thorium oxide (e.g., Th4O₇), thulium oxide (e.g., Tm₂O₃), and ytterbium oxide (e.g., Yb₂O₃), and combinations thereof;
“REO” refers to rare earth oxide(s); and
“transparent” means that the fused particles when viewed under an optical microscope at 100 times the magnification have the property of transmitting rays of visible light so that the bodies beneath the particles, such as bodies of the particles of the same nature, can be clearly seen through the particles when both are immersed in oil of approximately the same refractive index as the particles; although the oil should have a refractive index approximating that of the particles it should not be so close that the particles seem to disappear; the outline, periphery, or edges of bodies beneath the particles are clearly discernable.

Embodiments of transparent fused crystalline ceramics are useful, for example, as abrasive particles, reflective and optical components, and as grinding and sand blasting media.

### BRIEF DESCRIPTION OF THE DRAWING

FIG. 1 is a side view of an exemplary embodiment of an apparatus including a powder feeder assembly for a flame-melting apparatus.

FIG. 2 is a section view of the apparatus of FIG. 1.

FIG. 3 is an exploded section view of the apparatus of FIG. 1.

FIG. 4 is a side view of a portion of the powder feeder assembly of FIG. 1.

FIG. 5 is a perspective view of a portion of the powder feeder assembly of FIG. 1.

FIG. 6 is a cross-sectional view of a portion of the powder feeder assembly of FIG.

FIG. 7 is a differential thermal analysis (DTA) trace of Example 1 material.

### DETAILED DESCRIPTION

The present invention provides transparent fused crystalline (including polycrystalline) ceramics, and methods for making and using the same. Raw materials for making transparent fused crystalline ceramics according to the present invention and the melts from which such material is made include the following.

Sources, including commercial sources, of (on a theoretical oxide basis) Al₂O₃ include bauxite (including both natural occurring bauxite and synthetically produced bauxite), calcined bauxite, hydrated aluminas (e.g., boehmite, and gibbsite), aluminum, Bayer process alumina, aluminum ore, gamma alumina, alpha alumina, aluminum salts, aluminum nitrates, and combinations thereof. The Al₂O₃ source may provide only Al₂O₃. Alternatively, the Al₂O₃ source may provide Al₂O₃, as well as one or more metal oxides other than Al₂O₃ (including materials of or containing complex Al₂O₃.metal oxides (e.g., Dy₃Al₅O₁₂, Y₃A₅O₁₂, CeA₁₁O₁₈, etc.)). The Al₂O₃ source may also include, for example, minor amounts of silica, iron oxide, titania, and carbon.

Sources, including commercial sources, of (on a theoretical oxide basis) ZrO₂ include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the ZrO₂ source may contain, or provide ZrO₂, as well as other metal oxides such as hafnia. Sources, including commercial sources, of (on a theoretical oxide basis) HfO₂ include hafnium oxide powders, hafnium, hafnium-containing ores, and hafnium salts. In addition, or alternatively, the HfO₂ source may contain, or provide-HfO₂, as well as other metal oxides such as ZrO₂.

For embodiments comprising ZrO₂ and HfO₂, the weight ratio of ZrO₂:HfO₂ may be in a range of 1:zero (i.e., all ZrO₂; no HfO₂) to zero:1, as well as, for example, at least about 99, 98, 97, 96, 95, 90, 85, 80, 75, 70, 65, 60, 55, 50, 45, 40, 35, 30, 25, 20, 15, 10, and 5 parts (by weight) ZrO₂ and a corresponding amount of HfO₂ (e.g., at least about 99 parts (by weight) ZrO₂ and not greater than about 1 part HfO₂) and at least about 99, 98, 97, 96, 95, 90, 85, 80, 75, 70, 65, 60, 55, 50, 45, 40, 35, 30, 25, 20, 15, 10, and 5 parts HfO₂ and a corresponding amount of ZrO_{2.}

In some embodiments, the zirconia may be stabilized zirconia. Typical stabilizers for zirconia include yttria, calcia, magnesia, ceria, or other rare earth oxides.

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). Alternatively, the rare earth oxide(s) source may contain, or provide rare earth oxide(s), as well as one or more metal oxides other than rare earth oxide(s) (including materials of or containing complex rare earth oxide-other metal oxides (e.g., Dy₃Al₅O₁₂, CeAl₁₁O₁₈, etc.)).

Sources, including commercial sources, of (on a theoretical oxide basis) Y₂O₃ include yttrium oxide powders, yttrium, yttrium-containing ores, and yttrium salts (e.g., yttrium carbonates, nitrates, chlorides, hydroxides, and combinations thereof). The Y₂O₃ source may contain, or only provide, Y₂O₃. Alternatively, the Y₂O₃ source may contain, or provide Y₂O₃, as well as one or more metal oxides other than Y₂O₃ (including materials of or containing complex Y₂O₃.metal oxides (e.g., Y₃Al₅O₁₂)).

Other useful metal oxides may also include, on a theoretical oxide basis, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, and combinations thereof. Sources, including commercial sources, include the oxides themselves, metal powders, complex oxides, ores, carbonates, acetates, nitrates, chlorides, hydroxides, etc.

In some embodiments, it may be advantageous for at least a portion of a metal oxide source (in some embodiments, 10, 15, 20, 25, 30, 35, 40, 45, 50, 55, 60, 65, 70, 75, 80, 85, 90, 95, or even 100 percent by weight) to be obtained by adding particulate metallic material comprising at least one of a metal (e.g., Al, Ca, Cu, Cr, Fe, Li, Mg, Ni, Ag, Ti, Zr, and combinations thereof), M, that has a negative enthalpy of oxide formation or an alloy thereof, or otherwise combining them with the other raw materials. Although not wanting to be bound by theory, it is believed that the heat resulting from the exothermic reaction associated with the oxidation of the metal is beneficial in the formation of a homogeneous melt, resulting in fused crystalline, eutectic alumina-zirconia material with desirable crystalline microstructure features. For example, it is believed that the additional heat generated by the oxidation reaction within the feed particles eliminates, minimizes, or at least reduces insufficient heat transfer, and hence facilitates formation and homogeneity of the resulting melt. It is also believed that the availability of the additional heat aids in driving various chemical reactions and physical processes (e.g., densification, and spherodization) to completion. Further, it is believed for some embodiments, the presence of the additional heat generated by the oxidation reaction actually enables the formation of a melt, which otherwise is difficult or not practical due to high melting point of the materials. Another advantage of including particulate metallic material in forming the transparent fused crystalline ceramic is that many of the chemical and physical processes such as melting, densifying, and spherodizing can be achieved in a short time.

Particulate raw materials are typically selected to have particle sizes such that the formation of homogeneous feed particles, and in turn melt, can be achieved rapidly. Typically, raw materials with relatively small average particle sizes are used for this purpose. For example, those having an average particle size in a range from about 5 nm to about 50 micrometers (in some embodiments, in a range from about 10 nm to about 20 micrometers, or even about 15 nm to about 1 micrometer), wherein at least 90 (in some embodiments, 95, or even 100) percent by weight of the particulate is the raw material, although sizes outside of these ranges may also be useful. Particulate raw materials less than about 5 nm in size tends to be difficult to handle (e.g., the flow properties of the raw material particles tended to be undesirable as they tend to have poor flow properties). Use of raw material particulate larger in size than about 50 micrometers in typical flame forming processes tend to make it more difficult to obtain homogenous melts and transparent fused crystalline ceramic and/or the desired composition.

Further, in some cases, for example, when feed particles are fed in to a flame apparatus, to form the melt, it may be desirable for the particulate raw materials to be provided in a range of particle sizes. Although not wanting to be bound by theory, it is believed that this facilitates the packing density and strength of the feed particles. Further, raw material particles that are too coarse, tend to produce thermal and mechanical stresses in the feed particles, for example, during flame forming. The end result in such cases is generally, fracturing of the feed particles in to smaller fragments, loss of compositional uniformity, loss of yield, or even incomplete melting as the fragments generally change their trajectories in a multitude of directions out of the heat source.

In one aspect, the feed particles (which may include, or be, for example, previously-transparent fused crystalline ceramic) are fed independently into a flame to form the molten mixture. In another aspect, the feed particles may comprise previously transparent fused crystalline ceramic mixed together with other particulate raw materials. It is also within the scope of the present invention to feed previously transparent fused crystalline ceramic into a flame, while other raw materials are added independently into the flame to form the molten mixture. In the latter case, the mixing of the components is believed to occur by coalescing of the molten droplets in the flame.

In some embodiments, for example, the raw materials are combined or mixed together prior to melting to form the feed materials. The raw materials may be combined in any suitable and known manner to form a substantially homogeneous mixture. These combining techniques include ball milling, mixing, tumbling, and the like. The milling media in the ball mill may be, for example, metal balls, ceramic balls, and the like. The ceramic milling media may be, for example, alumina, zirconia, silica, magnesia, and the like. The ball milling may occur dry, in an aqueous environment, or in a solvent-based (e.g., isopropyl alcohol) environment. If the raw material batch contains metal powders, then it is generally desired to use a solvent during milling. This solvent may be any suitable material with the appropriate flash point and ability to disperse the raw materials. The milling time may be from a few minutes to a few days, generally between a few hours to 24 hours. In a wet or solvent based milling system, the liquid medium is removed, typically by drying and/or filtering, so that the resulting mixture is typically homogeneous and substantially devoid of the water and/or solvent. If a solvent based milling system is used, during drying, a solvent recovery system may be employed to recycle the solvent. After drying, the resulting mixture may be in the form of a “dried cake”. This cake-like mixture may then be broken up or crushed, for example, into the desired particle size prior to melting. Alternatively, for example, spray-drying techniques may be used. The latter typically provides spherical particulates of a desired oxide mixture. The feed material may also be prepared by wet chemical methods including precipitation and sol-gel. Such methods will be beneficial if extremely high levels of purity and homogeneity are desired.

It is within the scope of the present invention for the feed particles to be sintered material. Use of sintered material may be advantageous, for example, as any volatiles were removed during the sintering process, and conversion of precursor raw materials to corresponding oxides also occurred during the sintering process.

The size of feed particles can typically be up to 1000 micrometers (in some embodiments up to 500, 250, 100, or even up to 50 micrometers), and may have a narrow or wide particle size distribution. Generally, the feed particle size characteristics used are determined by the desired size (distribution) of the resulting transparent fused crystalline ceramic. Although not wishing to be bound by theory, it is believed, for example, for the resulting transparent fused crystalline ceramic may have a larger average particle size than the corresponding average feed particle size, due to coalescing of some molten particles in the flame. Further, it is also believed, for example, the transparent fused crystalline ceramic may have a substantially smaller average particle size than the corresponding feed particles, due to densification and fracturing of the feed particles in the flame. In general, it is desirable for the size of the feed particles to be larger than the largest particulate raw material powders, to facilitate mixing of the various components at the desired ratios. Also, there is generally an upper particle size limit for the feed particles for any composition. This upper particle size limit depends on a number of parameters, such as the thermal conductivity, heat capacity, etc., of the various components as well as the overall composition. Furthermore, the porosity of the feed particles, the type and the heat content of the flame, the residence time of the feed particles in the flame, and the occurrence and the type of chemical reactions among the components influence the largest allowable feed particle size.

It is within the scope of the present invention to provide one or more of the components of the feed material (i.e., the starting materials) in a form other than a particulate, including for example as precursor salts (e.g., as nitrates, acetates etc.), polymeric (e.g., silanes) or organometallic (e.g., alkoxides) form. The precursor salts, polymers, or the organometallics may be dissolved or dispersed in a suitable solvent (e.g., water, acetone, ethers, alcohols, and hydrocarbons (e.g., cyclohexane) prior to feeding in to the flame. Additionally, the feed particles may be dispersed, for example, in a solvent (e.g., water, acetone, ethers, alcohols, and hydrocarbons (e.g., cyclohexane)) prior to feeding into the flame. If the feed particles are dispersed in a solvent, it is desirable to control the size of the dispersion droplets in the flame. If the feed dispersion droplets are too big, volatilization of the solvent tends to be incomplete, and conversion of the feed particles in to melt droplets may not occur.

It is generally desirable for the feed particles to be fed into the flame, for example by techniques such as using screw feeders, vibratory feeders, and the like, without agglomeration, or so-called “clumping”. Undesirable agglomeration and/or clumping of the feed particles may cause incomplete or non-uniform melting of the particles, or highly porous final products. In some cases the feed particles may be mixed with colloidal (such as fumed silica and alumina) or lubricant (such as stearic acid) powders to keep feed particles monodispersed, and aid in uniform feeding in to the flame.

Transparent fused crystalline ceramics (e.g., particles) according to the present invention can be made by heating in a flame, the appropriate feed particles to form a melt, desirably a homogenous melt, and then rapidly cooling the melt to provide transparent fused crystalline ceramic according to the present invention. Some embodiments of transparent fused crystalline ceramic according to the present invention can be made, for example, by melting the metal oxide sources through any suitable furnace (e.g., an inductively or resistively heated furnace, a gas-fired furnace, or plasma melter). It is typically desirable to heat the melt 20° C. to 200° C. higher than the melting temperature to lower the viscosity of the melt and facilitate more complete mixing of the components.

The transparent fused crystalline ceramic is typically obtained by relatively rapidly cooling the molten material (i.e., the melt). The quench rate (i.e., cooling rate) to obtain the transparent fused crystalline ceramic depends upon many factors, including the chemical composition of the transparent fused crystalline ceramic, the thermal properties of the melt and the resulting transparent fused crystalline ceramic, the processing technique(s), the dimensions and mass of the resulting transparent fused crystalline ceramic, and the cooling technique.

The cooling rate is believed to affect the properties of the transparent fused crystalline ceramic. For instance, the density, average crystallite size, the eutectic cell size, the eutectic laminae size, the size of the primary crystals, phase composition, and/or other properties of fused crystalline, eutectic alumina-zirconia material typically change with cooling rates. Typically, the faster the cooling rate, the smaller the resulting crystal size, although if the cooling rate is too fast, the resulting material may be amorphous. Although not wanting to be bound by theory, the cooling rates achieved in making the transparent fused crystalline ceramic are believed typically to be higher than 10²° C./sec (i.e., a temperature drop of 100° C. from a molten state in less than 1 second); typically higher than 10° C./sec (i.e., a temperature drop of 1000° C. from a molten state in less than 1 second). Techniques for cooling the melt include discharging the melt into a cooling media (e.g., high velocity air jets, liquids (e.g., cold water), metal plates (including chilled metal plates), metal rolls (including chilled metal rolls), metal balls (including chilled metal balls), and the like). Other cooling techniques known in the art include roll-chilling. Roll-CHILLING can be carried out, for example, by melting the metal oxide sources at a temperature typically 20-200° C. higher than the melting point, and cooling the melt by spraying it under high pressure (e.g., using a gas such as air, argon, nitrogen or the like) onto a high-speed rotary roll(s). Typically, the rolls are made of metal and are water-cooled. Metal book molds may also be useful for cooling the melt. In some embodiments, the book molds and/or rollers, etc., are immersed in water.

Rapid cooling may also be conducted under controlled atmospheres, such as a reducing, neutral, or oxidizing environment to maintain and/or influence the desired oxidation states, the phase composition, etc. during cooling. The atmosphere can also influence crystal formation by influencing crystallization kinetics or mechanism from undercooled liquid. For example, larger undercooling of Al₂O₃ melts without crystallization has been reported in argon atmosphere as compared to that in air.

In one method, feed materials (which may include or be, for example fused crystalline, eutectic alumina-zirconia material to be re-melted and/or ceramic particles comprising glass) having the desired composition are converted into a melt, for example, using a flame forming process, and then cooling the melt to form transparent fused crystalline ceramic. An exemplary flame fusion process is reported, for example, in U.S. Pat. No. 6,254,981 (Castle). In this method, the metal oxide sources are fed (e.g., in the form of particles, sometimes referred to as “feed particles”) directly into a burner (e.g., a methane-air burner, an acetylene-oxygen burner, a hydrogen-oxygen burner, and the like).

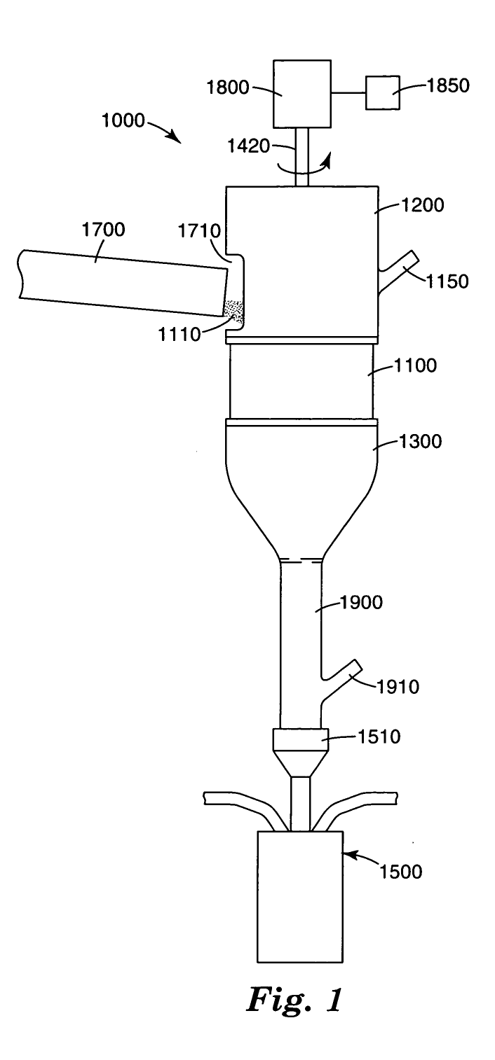

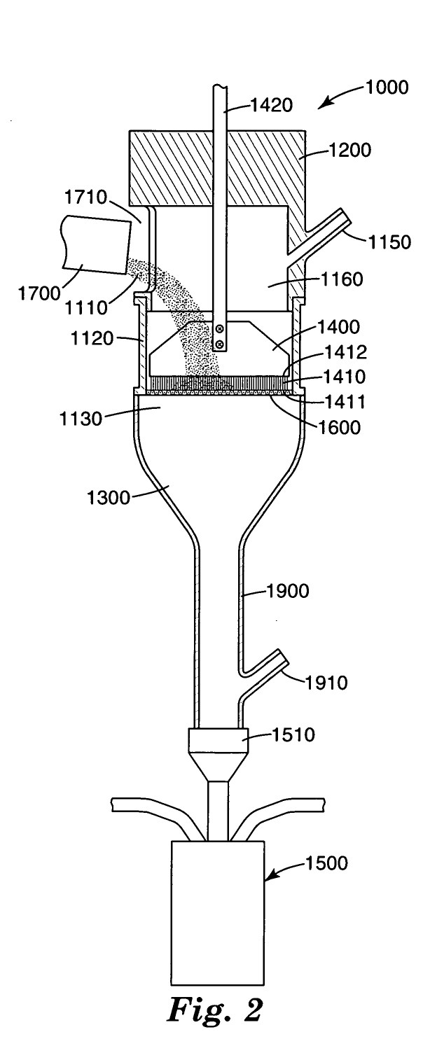

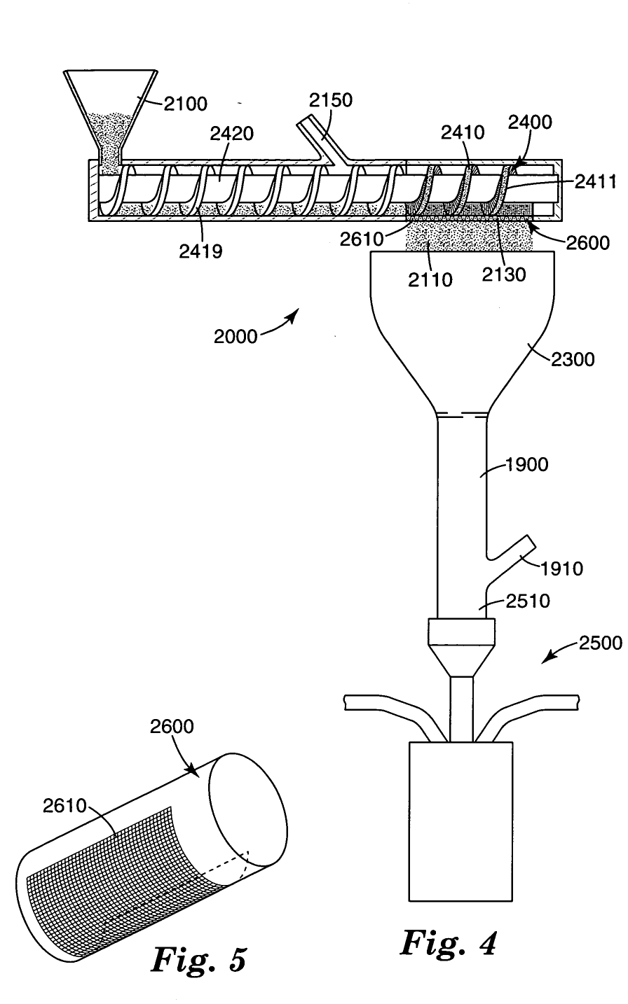

Another exemplary powder feeder apparatus is illustrated in FIGS. 1-6. The powder feeder assembly 1000 holds and delivers powder 1110 to a flame-melting device 1500. The flame-melting device 1500 includes a powder receiving section 1510 for receiving powder 1110 for melting and transforming into another material(s), such as those disclosed herein. Powder 1110 is delivered into the powder receiving section 1510 through a discharge opening 1130 of the powder feeder assembly 1000. A connecting tube 1900 is positioned between the discharge opening 1130 and the powder receiving section 1510. Also, a funnel 1300 is positioned proximate to the discharge 1130 opening for receiving and directing powder 1110 flow after it leaves the discharge opening 1130.

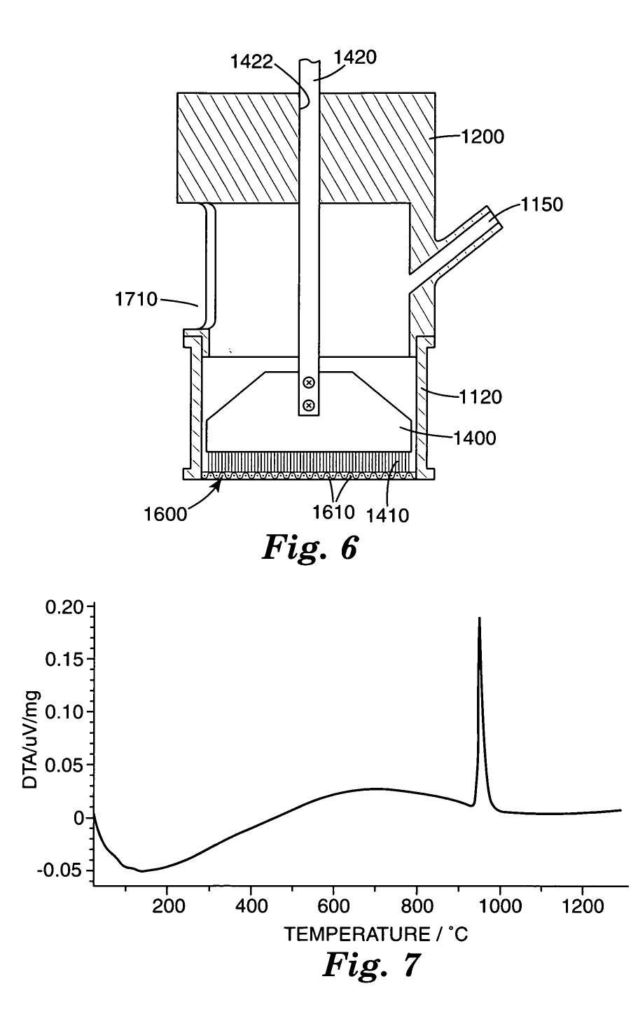

The powder feeder assembly 1000 includes a hopper 1100 for holding powder 1110. Typically, the hopper 1100 includes a body 1120 defined by a cylindrical wall, though other body shapes are possible. Also, the hopper 1100 can be made from a unitary piece or multiple pieces. The hopper 1100 in the example embodiment illustrated also includes a cover section 1200. The cover section 1200 includes an opening 1710 for feeding powder 1110 into the hopper 1100. Any commercially available delivery means can be used for filling the hopper 1100 with powder 1110, such as a screw feeder, vibratory feeder, or brush feeder. The cover section 1200 can also include a section 1415 having a shaft receiving opening 1422 (as illustrated in FIG. 6).

A brush assembly 1400 is disposed within the hopper 1100 body 1120. The brush assembly 1400 is connected to means for rotating the brush assembly 1400, such as a motor 1800. The motor 1800 can also be connected to means for adjusting the speed of the motor 1800, such as a motor speed controller 1850. The brush assembly used was a Nylon Strip Brush (1 inch (2.5 cm) overall height, 5/16 inch (0.8 cm) bristle length and 0.020 inch (5 millimeter) diameter), part #74715T61, available from McMaster-Carr, Chicago, Ill. The brush assembly was coupled to a shaft, which in turn was coupled to and driven by a DC Gear Motor (130 Volt, Ratio 60:1, Torque 22 Lb-in), available from Bodine Electric Company, Chicago, Ill. The speed of the motor was controlled using a Type-FPM Adjustable Speed PM Motor Control, Model #818, also available from Bodine.

The brush assembly 1400 includes a bristle element 1410 having a distal 1411 and a proximate end 1412. When powder 1110 is placed into the hopper 1100 for delivery to the flame-melting device 1500, the brush assembly 1400 is rotated within the hopper 1100. When the brush assembly 1400 is rotated, the, the bristle element(s) 1410 urges powder 1110 in the hopper 1100 through a screening member 1600. By adjusting the rotational speed of the brush assembly 1400, the feed rate of the powder 1110 through the screening member 1600 can be controlled.

The brush assembly 1400 cooperates with the screening member 1600 to deliver powder 1110 having desired properties from the discharge opening 1130 to the powder receiving section 1510 of the flame-melting device 1500. Distal end 1411 of bristle 1410 is located in close proximity to the screening member 1600. While a small gap between distal end 1411 of bristles 1410 and screening member 1600 can be used, it is typical to keep the gap on the same order of magnitude as the particle size of the powder, however, one of ordinary skill in the art will appreciate that the gap can be much larger, depending on the particular properties of the powder being handled. Also, distal end 1411 of bristle 1410 can be positioned flush with screening member 1600 or positioned to protrude into and extend through the mesh openings 1610 in the screening member 1600. For the bristles 1410 to protrude through the openings 1610, at least some of the bristles 1410 need to have a diameter smaller than the mesh size. Bristle elements 1410 can include a combination of bristles with different diameters and lengths, and any particular combination will depend on the operating conditions desired.

Extending the bristle 1400 end 1411 into and through the openings 1610 allows the bristles 1410 to break up any particles forming bridges across openings 1610. Also the bristles 1410 will tend to break-up other types of blockages that can occur typical to powder feeding. The bristle element 1410 can be a unitary piece, or can also be formed from a plurality of bristle segments. Also, if it is desired that the bristle elements extend into and/or through the mesh openings, then the bristle 1410 size selected needs to be smaller than the smallest mesh opening 1610.

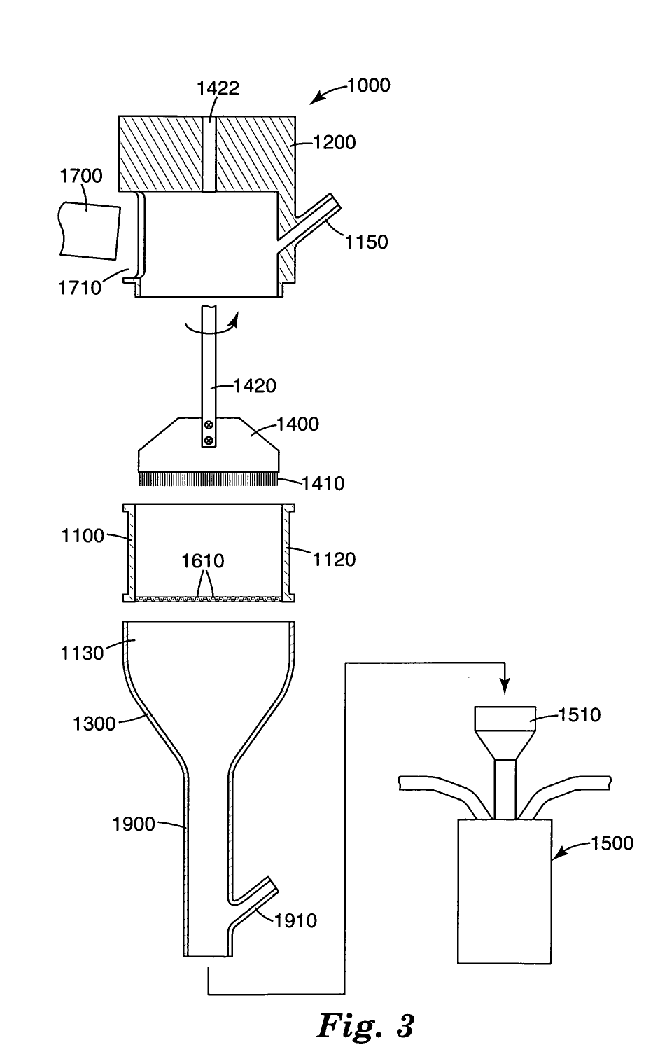

Referring to FIG. 3, in the exemplary embodiment illustrated, the hopper 1100 can include a wall defining a cylindrical body 1120. This shape conveniently provides for symmetry that allows for a more controlled flow rate of powder from the discharge opening 1130. Also, the cylindrical shape is well suited for using with a rotating brush assembly 1400, since the bristle element 1410 can extend to the wall, leaving little or no area on the screening member that can accumulate powder. However, other geometries are possible, as the particular conditions of use dictate.

The hopper 1100 also includes a cover section 1200. The cover section 1200 has an opening 1710 for receiving powder 1110 from a hopper feeder assembly 1700. The cover section 1200 cooperates with the body 1120 to form a powder chamber 1160. The opening 1710 on the cover 1200 can also be omitted or sealable so that a gas, such as nitrogen, argon, or helium can be input into a gas input line 1150 on the hopper 1100 for neutralizing the atmosphere or assisting in delivering the powder or particles to the flame-melting device. Also, gas can be used in the system for controlling the atmosphere surrounding the powder or particles. Also, a gas input line 1910 can be placed after the discharge opening 1130, for example, on the connecting tube 1900.

The entire powder feeder assembly 1000 can be vibrated to further assist in powder transport. Optionally, the screening member can be vibrated to assist powder transport through the powder feeder assembly 1000. One of ordinary skill in the art will recognize that other possible vibrating means can be used, and there are abundant commercial vibrating systems and devices that are available depending on the particular conditions of use.

Referring to FIG. 6, when hopper 1100 includes a cover 1200 and a body 1120, the removable cover 1200 allows easy access to powder chamber 1160 for cleaning or changing the screening member 1600. Also, the brush assembly 1400 can be positioned to form the desired engagement between the bristle elements 1410 and the screening member 1600. When the brush assembly 1400 is attached to a rotating shaft 1420, the shaft 1420 can protrude outside opening 1422 in the cover 1200 to be driven, for example, by a motor 1800. The speed of the brush assembly 1400 can be controlled by means such as a speed controller 1850. Further details regarding this exemplary powder feeding apparatus can be found in co-pending application having U.S. Ser. No. ______ (Attorney Docket No. 59440US002), filed the same date as the instant application, the disclosure of which is incorporated herein by reference.

Embodiments of the transparent fused crystalline ceramic may also be obtained by other techniques, such as: thermal (including flame or laser or plasma-assisted) pyrolysis of suitable precursors, physical vapor synthesis (PVS) of metal precursors and mechanochemical processing. Further, other techniques for making melts and transparent fused crystalline ceramic include plasma spraying, melt-extraction, and gas or centrifugal atomization.

The rollers, surfaces, etc. can be made of a variety of materials including metals (e.g., steels (including stainless steel and alloy steels), copper, brass, aluminum and aluminum alloys, and nickel) or graphite. Generally, suitable materials have high thermal conductivity and good thermal stability against rapid temperature changes and good stability against mechanical shocks. In some embodiments, the molds or various surfaces may employ a liner to facilitate, for example, more cost efficient maintenance and/or initial design and acquisition of the surfaces. For example, the core of the surfaces may be of one material while the liners may be another with the desired thermal, chemical, and mechanical properties. The liners may be more or less expensive, easier to machine than the core, etc. Further, liners may be replaced after one or more uses. To improve the heat removing ability of the rollers, surfaces, etc. they may be cooled, for example, by circulating liquid (e.g., water) and/or by blowing a cooling gas (e.g., air, nitrogen, and argon) on them, as well as immersing the rollers in a cooling medium (e.g., water).

The rollers and surfaces can be in a variety of sizes, depending, for example, on the size of the operation, the desired quantity of particles, the amount of melt to be processed, and/or the flow rate of the melt. The speed at which the rollers, and/or surfaces move may depend, for example, on the desired cooling rates, the material output of the process, etc.

If size reduction and/or change in particle shape is desired, such reduction and/or change in particle shape can be obtained, for example, using crushing and/or comminuting techniques known in the art. Such particles can be converted into smaller pieces and/or different shapes, or for example, using crushing and/or comminuting techniques known in the art, including roll crushing, jaw crushing, hammer milling, ball milling, jet milling, impact crushing, and the like. In order to produce the desired particle size distribution (sometimes referred to as grit size or grade), it may be necessary to perform multiple crushing steps. In general the crushing conditions are optimized to achieve the desired particle shape(s) and particle size distribution. Resulting particles that are not of the desired size may be re-crushed if they are too large. In another aspect, if resulting particles are not of the desired size they may be used as a raw material for re-melting.

The shape of the transparent fused crystalline ceramic particles according to the present invention can depend, for example, on the composition and/or microstructure of the ceramic, the geometry in which it was cooled, and the manner in which the ceramic is crushed (i.e., the crushing technique used). In general, where a “blocky” shape is preferred, more energy may be employed to achieve this shape. Conversely, where a “sharp” shape is preferred, less energy may be employed to achieve this shape. The crushing technique may also be changed to achieve different desired shapes. For some particles an average aspect ratio ranging from 1:1 to 5:1 is typically desired, and in some embodiments 1.25:1 to 3:1, or even 1.5:1 to 2.5:1.

The addition of certain metal oxides may alter the properties and/or crystalline structure or microstructure of transparent fused crystalline ceramics according to the present invention.

The particular selection of metal oxide sources and other additives for making transparent fused crystalline ceramics according to the present invention typically takes into account, for example, the desired composition, the microstructure, the degree of crystallinity, the physical properties (e.g., hardness or toughness), the presence of undesirable impurities, and the desired or required characteristics of the particular process (including equipment and any purification of the raw materials before and/or during fusion and/or solidification) being used to prepare the ceramics.

In some instances, it may be desirable to incorporate limited amounts of metal oxides selected from the group consisting of: BaO, CaO, Cr₂O₃, CoO, CuO, Fe₂O₃, GeO₂, HfO₂, Li₂O, MgO, MnO, NiO, Na₂O, Sc₂O₃, SrO, TiO₂, Y₂O₃, rare earth oxides, ZnO, and combinations thereof. Sources, including commercial sources, include the oxides themselves, complex oxides, elemental powders, ores, carbonates, acetates, nitrates, chlorides, hydroxides, etc. If the modifying metal oxides are added in a form that is volatile, it is desirable to convert the volatile species the corresponding oxides or remove the volatiles by a suitable heat treatment such as calcination or sintering, prior to flame forming. If the volatile species are not removed prior to the flame forming, the residual volatile species typically tend to cause formation of substantial porosity (i.e., bubbles) in the resulting ceramic. Alternatively, the resulting fused materials may be fed through the flame multiple times to allow escape of the gases and increase the density of the materials.

The metal oxides when used are typically added from greater than 0 to 35 (in some embodiments, than 0 to 30, greater than 0 to 25, greater than 0 to 20, greater than 0 to 15, greater than 0 to 10, greater than 0 to 5, or even greater than 0 to 2) percent by weight collectively of the transparent fused crystalline ceramic.

Some metal oxides (e.g., yttria, calcia, magnesia, ceria, and rare earth oxides) known to stabilize the tetragonal (cubic) forms of the zirconia may be added into the composition by the use of stabilized zirconia powders, or may be added independently as part of the feed materials. The stabilizing oxides tend to increase the percent tetragonal (cubic) zirconia content of the resulting transparent fused crystalline ceramics according to the present invention. In some embodiments, the oxide additives (e.g., yttria, calcia, magnesia, ceria, and rare earth oxides) may contribute to the formation of ternary or even higher order eutectics. The microstructural features of ternary or higher order eutectics are typically similar to those of binaries, although the physical properties may be significantly different.

Transparent fused crystalline ceramics according to the present invention may contain a minor (typically less than about 10 (or even less than 5, 4, 3, 2, or even less than 1) percent by weight) amount of amorphous/glass material.

In some embodiments, carbon impurities that may be in transparent fused crystalline ceramics according to the present invention are not greater than 1 (in some embodiments, not greater than 0.5, or even not greater than 0.25) percent by weight, based on the total weight of the material. Other impurities that may be present in transparent fused crystalline ceramics include silica, iron oxides, titania, and their reaction products.

The microstructure or phase composition of a material can be determined, for example, using electron microscopy and x-ray diffraction (XRD). Using powder x-ray, diffraction, XRD, (using.an x-ray diffractometer such as that obtained under the trade designation “PHILLIPS XRG 3100” from Phillips, Mahwah, N.J., with copper K α1 radiation of 1.54050 Angstrom) the phases present in a material can be determined by comparing the peaks present in the XRD trace of the crystallized material to XRD patterns of crystalline phases provided in JC.PDS (Joint Committee on Powder Diffraction Standards) databases, published by International Center for Diffraction Data.

Examples of crystalline phases which may be present in transparent fused crystalline ceramics provided by the present invention include: Al₂_{O}₃ (e.g., alpha alumina and transition alumina), ZrO₂ (e.g., cubic and tetragonal ZrO₂), REO, Y₂O₃, MgO, BaO, CaO, Cr₂O₃, CoO, Fe₂O₃, GeO₂, Li₂O, MnO, NiO, Na₂O, P₂O₅, Sc₂O₃, SiO₂, SrO, Te)₂, TiO₂, V₂O₅, ZnO, HfO₂, as well as “complex metal oxides” (including complex Al₂O₃.metal oxide (e.g., complex Al₂O₃.REO)), complex Al₂O₃.metal oxide(s) (e.g., complex Al₂O₃.REO (e.g., ReAlO₃ (e.g., GdAlO₃ LaAlO₃), ReAl₁O₁₈ (e.g., LaAl₁₁O₁₈,) and Re₃Al₅O₁₂ (e.g., Dy₃Al₅O₁₂)), complex Al₂O₃.Y₂O₃ (e.g., Y₃Al₅O₁₂), and complex ZrO₂.REO (e.g., La₂Zr₂O₇)), and combinations thereof.

Although not wanting to be bound by theory, it is believed that the relative fractions of alpha-alumina to transitional-alumina phases are determined at least in part by the cooling rates. It is believed higher cooling rates generally promote formation of more transitional alumina phases. The desired amounts of alpha-alumina and transitional alumina in transparent fused crystalline ceramics according to the present invention depend on the intended use. For abrasive applications requiring high rates of material removal, higher percentages of alpha alumina are typically desired. On the other hand if low rates of material removal are desired, such as during polishing, higher percentages of transitional alumina may be desired.

It is also with in the scope of the present invention to substitute a portion of the aluminum cations in a complex Al₂O₃.metal oxide (e.g., complex Al₂O₃.REO and/or complex Al₂O₃.Y₂O₃ (e.g., yttrium aluminate exhibiting a garnet crystal structure)) with other cations. For example, a portion of the Al cations in a complex Al₂O₃.Y₂O₃ may be substituted with at least one cation of an element selected from the group consisting of: Cr, Ti, Sc, Fe,.Mg, Ca, Si, Co, and combinations thereof. For example, a portion of the Y cations in a complex Al₂O₃.Y₂O₃ may be substituted with at least one cation of an element selected from the group consisting of: Ce, Dy, Er, Eu, Gd, Ho, La, Lu, Nd, Pr, Sm, Th, Tm, Yb, Fe, Ti, Mn, V, Cr, Co, Ni, Cu, Mg, Ca, Sr, and combinations thereof. Further, for example, a portion of the rare earth cations in a complex Al₂O₃.REO may be substituted with at least one cation of an element selected from the group consisting of: Y, Fe, Ti, Mn, V, Cr, Co, Ni, Cu, Mg, Ca, Sr, and combinations thereof. The substitution of cations as described above may affect the properties (e.g. hardness, toughness, strength, thermal conductivity, etc.) of transparent fused crystalline ceramics according to the present invention.

The average crystal and eutectic cell size, as well as the average thickness of the eutectic laminae, can be determined by the line intercept method according to the ASTM standard E 112-96 “Standard Test Methods for Determining Average Grain Size”. The sample is mounted in mounting resin (such as that obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (such as that obtained from Buehler, Lake Bluff, Ill. under the trade designation “ECOMET 3”). The sample is polished for about 3 minutes with a diamond wheel containing 125-micrometer diamonds, followed by 5 minutes of polishing with each of 45, 30, 15, 9, 3, and 1-micrometer slurries. The mounted and polished sample is sputtered with a thin layer of gold-palladium and viewed using a scanning electron microscopy (such as Model JSM 840A from JEOL, Peabody, MA). A typical back-scattered electron (BSE) photomicrograph of the microstructure found in the sample is used to determine the average crystallite size as follows. The number of crystallites that intersect per unit length (NL) of a random straight line drawn across the photomicrograph are counted. The average crystallite size is determined from this number using the following equation.

$$Average Crystallite Size = \frac{1.5}{{N}_{L} M} ,$$

where NL is the number of crystallites intersected per unit length and M is the magnification of the photomicrograph. The average eutectic cell size, as well as the average thickness of eutectic laminae, is determined in the same manner except the number of eutectic cells or the eutectic laminae are counted, respectively. Further, the shape of primary crystals, additive oxide crystals, and the eutectic cells can be determined using electron microscopy. A typical secondary electron image can also be used if the contrast among the phases present is large enough for this purpose. The aspect ratios of primary and additive oxide crystals, and the eutectic cells are determined by dividing the length (i.e., the longest dimension) by the largest width (measured perpendicular to the length).

In some embodiments, transparent fused crystalline ceramics according to the present invention comprise laminae, wherein the eutectic laminae have thicknesses less than 300 nanometers (in some embodiments, less than 250, 200, 150, or even less than 100 nanometers).

In some embodiments, transparent fused crystalline ceramics according to the present invention do not exhibit any eutectic cells (i.e., the overall dimensions of the ceramic are the cell boundaries).

The average hardness of transparent fused crystalline ceramics according to the present invention can be determined as follows. Sections of the material are mounted in mounting resin (obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (such as that obtained from Buehler, Lake Bluff, Ill. under the trade designation “ECOMET 3”). The sample is polished for about 3 minutes with a diamond wheel containing 125-micrometer diamonds, followed by 5 minutes of polishing with each of 45, 30, 15, 9, 3, and 1-micrometer slurries. The microhardness measurements are made using a conventional microhardness tester (such as that obtained under the trade designation “MITUTOYO MVK-VL” from Mitutoyo Corporation, Tokyo, Japan) fitted with a Vickers indenter using a 100-gram indent load. The microhardness measurements are made according to the guidelines stated in ASTM Test Method E384 Test Methods for Microhardness of Materials (1991). The average hardness is an average of 10 measurements.

Embodiments of transparent fused crystalline ceramics according to the present invention have an average hardness of at least 12 GPa, in some embodiments, at least 13 GPa, 14 GPa, or even at least 15 GPa. Abrasive particles according to the present invention have an average hardness of at least 12 GPa, in some embodiments, at least 13 GPa, 14 GPa, or even at least 15 GPa.

Embodiments of transparent fused crystalline ceramics according to the present invention have densities of at least 75% (in some embodiments, at least 80%, 85%, 90%, 92%, 95%, 96%, 97%, 98%, 99%, 99.5%, or even 100%) of theoretical density. Abrasive particles according to the present invention have densities of at least 75% (in some embodiments, at least 80%, 85%, 90%, 92%, 95%, 96%, 97%, 98%, 99%, 99.5% or even 100%) of theoretical density.

Transparent fused crystalline ceramic particles may be used in a wide range of particle sizes, typically ranging in size from about 0.1 to about 5000 micrometers, about 1 to about 2000 micrometers, about 5 to about 1500 micrometers, or even in some embodiments, from about 100 to about 1500 micrometers.

Transparent fused crystalline ceramic abrasive particles according the present invention can be incorporated into an abrasive article, or used in loose form. Abrasive particles are usually graded to a given particle size distribution before use. Such distributions typically have a range of particle sizes, from coarse particles to fine particles. In the abrasive art this range is sometimes referred to as a “coarse”, “control”, and “fine” fractions. Abrasive particles graded according to abrasive industry accepted grading standards specify the particle size distribution for each nominal grade within numerical limits. Such industry accepted grading standards (i.e., specified nominal grades) include those known as the American National Standards Institute, Inc. (ANSI) standards, Federation of European Producers of Abrasive Products (FEPA) standards, and Japanese Industrial Standard (JIS) standards.

In one aspect, the present invention provides a plurality of abrasive particles having a specified nominal grade, wherein at least a portion of the plurality of abrasive particles are transparent fused crystalline ceramic abrasive particles according to the present invention. In some embodiments, at least 5, 10, 15, 20, 25, 30, 35, 40, 45, 50, 55, 60, 65, 70, 75, 80, 85, 90, 95, or even 100 percent by weight of the plurality of abrasive particles are transparent fused crystalline ceramic abrasive particles according to the present invention, based on the total weight of the plurality of abrasive particles. In some embodiments, the fused crystalline, eutectic alumina-zirconia abrasive particles according to the present invention are crushed or otherwise reduced in size prior to grading.

In another aspect, the present invention provides an abrasive article (e.g., a bonded abrasive article, a non-woven abrasive article, or a coated abrasive article) comprising a binder and a plurality of abrasive particles, wherein at least a portion of the abrasive particles are transparent fused crystalline ceramic abrasive particles according to the present invention.

Abrasive articles comprise binder and a plurality of abrasive particles, wherein at least a portion of the abrasive particles are transparent fused crystalline ceramic abrasive particles according to the present invention. Exemplary abrasive products include coated abrasive articles, bonded abrasive articles (e.g., wheels), non-woven abrasive articles, and abrasive brushes. Coated abrasive articles typically comprise a backing having first and second, opposed major surfaces, and wherein the binder and the plurality of abrasive particles form an abrasive layer on at least a portion of the first major surface.

In some embodiments, at least 5, 10, 15, 20, 25, 30, 35, 40, 45, 50, 55, 60, 65, 70, 75, 80, 85, 90, 95, or even 100 percent by weight of the abrasive particles in an abrasive article are transparent fused crystalline ceramic abrasive particles according to the present invention, based on the total weight of the abrasive particles in the abrasive article.

Furthermore, transparent fused crystalline ceramic abrasive particles according to the present invention can be used in abrasive applications that utilize abrasive particles, such as slurries of abrading compounds (e.g., polishing compounds), milling media, shot blast media, vibratory mill media, and the like.

Transparent fused crystalline ceramic abrasive particles according to the present invention may be useful, for example, to abrade workpieces such as aluminum metal, carbon steels, mild steels, tool steels, stainless steel, hardened steel, titanium, glass, ceramics, wood, wood-like materials (e.g., plywood and particle board), paint, painted surfaces, organic coated surfaces and the like. The applied force during abrading typically ranges from about 1 to about 100 kilograms.

After screening, there will typically be a multitude of different abrasive particle size distributions or grades. These multitudes of grades may not match a manufacturer's or supplier's needs at that particular time. To minimize inventory, it is possible to recycle the off demand grades back into melt for making transparent fused crystalline ceramic abrasive particles according to the present invention. This recycling may occur after the crushing step, where the particles are in large chunks or smaller pieces (sometimes referred to as “fines”) that have not been screened to a particular distribution.

Advantages and embodiments of this invention are further illustrated by the following non-limiting examples, but the particular materials and amounts thereof recited in these examples, as well as other conditions and details, should not be construed to unduly limit this invention. All parts and percentages are by weight unless otherwise indicated.

### EXAMPLE 1

A 250-ml polyethylene bottle (7.3-cm diameter) was charged with 17.5 grams aluminum oxide powder (obtained from Alcoa Industrial Chemicals, Bauxite, Ark., under the trade designation “Al6SG”), 27.7 grams of aluminum powder (-325 mesh, obtained from Alfa-Aesar, Bond Hill, Mass.), 54.8 grams zirconium oxide powder (obtained from Zirconia Sales, Inc. of Marietta, Ga. under the trade designation “DK-2 ”), 100 grams of isopropyl alcohol and 200 grams of alumina milling media (cylindrical shape, both height and diameter of 0.635 cm; 99.9% alumina; obtained from Coors, Golden, Colo.). The contents of the polyethylene bottle were milled for 16 hours at 60 revolutions per minute (rpm). After the milling, the milling media were removed and the slurry was poured onto a warm (about 75° C.) glass (“PYREX”) pan in a layer, and allowed to cool and dry. Due to the relatively thin layer of the material (i.e., about 3 mm think) of slurry and the warm pan, the slurry formed a cake within 5 minutes and dried in about 30 minutes. The dried mixture was ground by screening through a 100-mesh screen (180-micrometer opening size) with the aid of a paintbrush.

The resulting screened particles were fed slowly (about 0.5 gram/minute) through a funnel, which was attached to a powder feeder, under a flowing nitrogen gas atmosphere 5 standard liter per minute (SLPM), into a hydrogen/oxygen torch flame which melted the particles and carried them directly into a 19-liter (5-gallon) rectangular container (41 centimeters (cm), by 53 cm, by 18 cm height) of continuously circulating, turbulent water (20° C.) to rapidly quench the molten droplets. The powder feeder comprised a canister (8 cm diameter) at the bottom of which was a 100-mesh screen (150 micrometer opening size). The particular powder feeder used is that illustrated in FIGS. 1-6, as described above, wherein the screens were made from stainless steel (available from W.S. Tyler Inc., Mentor, Ohio). The powder was filled into the canister and was forced through the openings of the screen using a rotating brush. The torch was a Bethlehem bench burner PM2D Model B obtained from Bethlehem Apparatus Co., Hellertown, Pa. The torch had a central feed port (3/16 inch (0.47 cm) inner diameter) through which the feed particles were introduced into the flame. Hydrogen and oxygen flow rates for the torch were as follows. The hydrogen flow rate was 42 standard liters per minute (SLPM) and the oxygen flow rate was 18 SLPM. The angle at which the flame hit the water was about 90°, and the flame length, burner to water surface, was approximately 31 centimeters (cm). The resulting (quenched) particles were collected in a pan and heated at 110° C. in an electrically heated furnace till dried (about 30 minutes). The particles were spherical in shape and up to about 106 micrometers (140 mesh) in diameter.

A percent transparent yield was calculated from the resulting flame formed beads using the −140+200 mesh size fraction (i.e., the fraction collected between 106-micrometer opening size and 75-micrometer opening size screens). The measurements were done in the following manner. A single layer of beads was spread out upon a glass slide. The beads were observed at 32× using an optical microscope. Using the crosshairs in the optical microscope eyepiece as a guide, beads that lay horizontally coincident with crosshair along a straight line were counted either transparent or opaque depending on their optical clarity. A total of 500 beads were counted and a percent transparent yield was determined by the number of transparent beads divided by total beads counted and multiplied by 100. The particles were predominantly transparent (>90% by number).

Differential thermal analysis (DTA) was conducted on beads of Example 1 as follows: A DTA run was made (using an instrument obtained from Netzch Instruments, Selb, Germany under the trade designation “NETZCH STA 409 DTA/TGA” using a −140+170 mesh size fraction (i.e., the fraction collected between 106-micrometer opening size and 90-micrometer opening size screens). An amount of each screened sample was placed in a 100-microliter Al₂O₃ sample holder. Each sample was heated in static air at a rate of 10° C./minute from room temperature (about 25° C.) to 1100° C.

The DTA trace of beads prepared in Example 1, shown in FIG. 7, exhibited an exothermic event at a temperature of 952.8° C. It is believed that this event corresponds to the crystallization of the amorphous material contained in the material.

Powder X-ray diffraction, XRD, (using an X-ray diffractometer (obtained under the trade designation “PHILLIPS XRG 3100” from Phillips, Mahwah, N.J.) with copper K α1 radiation of 1.54050 Angstrom) was used to determine the phases present in the Example 1 material. The phases were determined by comparing the peaks present in the XRD trace of the crystallized material to XRD patterns of crystalline phases provided in JCPDS databases, published by International Center for Diffraction Data. The crystalline phases identified for Example 1 were tetragonal/cubic ZrO₂, and a mixture of transitional- and minor amount of alpha-Al₂O₃ phases. The XRD peaks were broad indicating that the material contained very fine (nano)-crystalline particles/phases and possibly some amorphous material.

A sample was prepared for microstructure analysis as follows. About 1 gram of the Example 1 particles was mounted in mounting resin (obtained under the trade designation “TRANSOPTIC POWDER” from Buehler, Lake Bluff, Ill.). The resulting cylinder of resin was about 2.5 cm in diameter and about 1.9 cm high. The mounted section was prepared using conventional polishing techniques using a polisher (obtained from Buehler, Lake Bluff, Ill. under the trade designation “ECOMET 3”). The sample was polished for about 3 minutes with a diamond wheel containing 125-micrometer diamonds, followed by 5 minutes of polishing with each of 45, 30, 15, 9, 3, and 1-micrometer slurries. The mounted and polished sample was coated with a thin layer of gold-palladium and viewed using a JEOL SEM (Model JSM 840A). The beads were very dense and did not show any microstructural features at a magnification of about 10,000×, again indicating that the material contained very fine (nano)-crystalline particles/phases and possibly contained some amorphous material.

Various modifications and alterations. of this invention will become apparent to those skilled in the art without departing from the scope and spirit of this invention, and it should be understood that this invention is not to be unduly limited to the illustrative embodiments set forth herein.

1. Transparent fused crystalline ceramic comprising in a range from 45 to 80 percent by weight A1₂O₃ and in a range from 55 to 20 percent by weight ZrO₂, based on the total weight of the transparent fused crystalline ceramic.

2. Transparent fused polycrystalline ceramic comprising in a range from 45 to 80 percent by weight Al₂O₃ and in a range from 55 to 20 percent by weight ZrO2, based on the total weight of the transparent fused crystalline ceramic.

3. The transparent fused polycrystalline ceramic according to claim 2 comprising collectively at least 80 percent by weight Al₂O₃ and ZrO₂, based on the total weight of the transparent fused polycrystalline ceramic.

4. The transparent fused polycrystalline ceramic according to claim 2 comprising collectively at least 90 percent by weight Al₂O₃ and ZrO₂, based on the total weight of the transparent fused polycrystalline ceramic.

5. The transparent fused polycrystalline ceramic according to claim 2 comprising Al₂O₃ in a range from 50 to 70 percent by weight and ZrO₂ in a range from 50 to 30 percent by weight, based on the total weight of the fused polycrystalline ceramic.

6. The transparent fused polycrystalline ceramic according to claim 2 comprising laminae, wherein the laminae have thicknesses less than 250 nanometers.

7. The transparent fused polycrystalline ceramic according to claim 2, wherein the material in the form of a particle.

8. A plurality of particles according to claim 7.

9. The particles according to claim 8 having particle sizes in a range from 1 micrometer to 2000 micrometers.

10. The particles according to claim 2, wherein the fused polycrystalline, eutectic alumina-zirconia material comprises laminae, and wherein the laminae have thicknesses less than 250 nanometers.

11. A method of making the plurality of transparent fused polycrystalline ceramic particles according to claim 8, the method comprising:
flame forming a melt, the melt comprising Al₂O₃ and ZrO₂ collectively at least 65 percent by weight Al₂O₃ and ZrO₂, based on the total weight of the melt;
shaping the melt into precursor particles; and
cooling the precursor particles to directly provide the transparent fused polycrystalline ceramic particles.

12. The.method according to claim 11, wherein the flame forming is conducted at no more than 2500° C.

13. The method according to claim 11, wherein the transparent fused polycrystalline ceramic comprises laminae, and wherein the laminae have thicknesses less than 250 nanometers.

14. A method of making the plurality of transparent fused polycrystalline ceramic particles according to claim 8, the method comprising:
flame forming a melt, the melt comprising Al₂O₃ and ZrO₂ collectively at least 65 percent by weight Al₂O₃ and ZrO₂, based on the total weight of the melt;
cooling the melt to provide transparent fused polycrystalline ceramic;
crushing the transparent fused polycrystalline ceramic material to provide the transparent fused polycrystalline ceramic particles.

15. The method according to claim 14 wherein the flame forming is conducted at no more than 2500° C.

16. A method of making the transparent fused polycrystalline ceramic according to claim 8, the method comprising:
flame forming a melt, the melt comprising Al₂O₃ and ZrO₂ collectively at least 65 percent by weight Al₂O₃ and ZrO2, based on the total weight of the melt; and
cooling the melt to directly provide the transparent fused polycrystalline ceramic.

17. The method according to claim 16, wherein the flame forming is conducted at no more than 2500° C.

18. The method according to claim 16, wherein the fused polycrystalline, eutectic alumina-zirconia material comprises laminae, and wherein the laminae have thicknesses less than 250 nanometers.
